(19) United States
(12) Patent Application Publication
(10) Pub. No.: US 2016/0150562 A1
(43) Pub. Date: May 26, 2016

(54) TRANSMISSION DEVICE

(71) Applicant: SHARP KABUSHIKI KAISHA, Osaka-shi, Osaka (JP)

(72) Inventors: Osamu NAKAMURA, Osaka-shi (JP); Jungo GOTO, Osaka-shi (JP); Yasuhiro HAMAGUCHI, Osaka-shi (JP)

(73) Assignee: Sharp Kabushiki Kaisha, Osaka-shi, Osaka (JP)

(21) Appl. No.: 14/901,201

(22) PCT Filed: Jun. 25, 2014
(86) PCT No.: PCT/JP2014/066838

§ 371 Date: Dec. 28, 2015

(30) Foreign Application Priority Data
Jun. 27, 2013 (JP) 2013-134651

(51) Int. Cl. H04W 72/12; H04L 1/00; H04L 5/00

(52) U.S. Cl. CPC H04W 72/1294; H04L 5/0048; H04L 1/0061; H04L 5/0094

(57) ABSTRACT

An amount of control information per subframe is reduced by keeping the amount of control information constant in both a case where multi-subframe scheduling is performed and a case where multi-subframe scheduling is not performed.

### TECHNICAL FIELD

The present invention relates to transmission devices.

The present disclosure contains subject matter related to that disclosed in Japanese Patent Application No. 2013-134651 filed in the Japan Patent Office on Jun. 27, 2013, the entire contents of which are hereby incorporated by reference.

### BACKGROUND ART

Along with the recent widespread use of smartphones and the like, there has been a growing demand for high-speed wireless transmissions. The 3GPP (Third Generation Partnership Project), which is one of standardization organizations, is developing technical specifications for LTE (Long Term Evolution). At the present day, the 3GPP has almost finished developing technical specifications for Rel-11 and is developing technical specifications for Rel-12.

In wireless communications systems such as LTE, a base station apparatus is connected to a plurality of terminal devices; therefore, the plurality of terminal devices share resources such as frequencies and time. Accordingly, in LTE (during use of normal CP), as shown in FIG. 1, a time resource is controlled with fourteen OFDM symbols as one subframe and, furthermore, with ten subframes as one wireless frame. Note here that the duration of one wireless frame is 10 ms and the duration of one subframe is 1 ms.

Further, frequency resources are controlled in units of resource blocks (RB). As shown in FIG. 2, one RB is constituted by 168 resource elements (REs) of twelve subcarriers by fourteen OFDM symbols. Communication is performed with a large number of RBs allocated to a terminal device to which a large amount of information is to be transmitted.

For example, in the case of a downlink (DL) transmission, the base station apparatus determines how many RBs to allocate to each terminal device and notifies the terminal device of allocation information. For the notification of the allocation information, a PDCCH (physical downlink control channel) is used, for example. The PDCCH is transmitted from the base station apparatus to the terminal device using a plurality of first symbols (e.g., the diagonally shaded symbols in FIG. 2) of one subframe. The terminal device receives the PDCCH, decodes the PDCCH, and obtains the allocation information. Data allocation is performed using a PDSCH (indicated by the white REs) within the same subframe. That is, the allocated RBs are notified by the PDCCH, and their allocation is performed within the same subframe.

Further, in the case of an FDD (frequency division duplex) uplink (UL) transmission, a PDCCH is for example used for notification of allocation information, as in the case of DL. However, unlike in the case of DL, the notification is performed using a PUSCH (physical uplink shared channel) in the fourth subframe after a subframe containing a PDCCH by which allocation was notified. For example, as shown in FIG. 3, a terminal device notified of uplink allocation on PDCCHs in the second and fourteenth subframes transmits PUSCHs using the sixth and eighteenth frames.

In this way, under the specifications up to LTE Rel-11, one data channel (PDSCH or PUSCH) is allocated by one PDCCH. Therefore, for example, the allocation of four consecutive subframes to a terminal device requires the base station apparatus to notify the terminal device of four PDCCHs. However, since there is not much change in propagation environment in consecutive frames, the base station apparatus is highly likely to wastefully notify the terminal device of the same control information (allocation information, an MCS (modulation and coding scheme), and a PMI (precoding matrix indicator)).

Accordingly, LTE Rel-12 proposes multi-subframe scheduling (MSS; referred to also as multi-TTI scheduling), which enables scheduling across a plurality of subframes using one PDCCH, as shown in FIG. 4. Since MSS enables the allocation of a plurality of subframes using one PDCCH, downlink control information can be reduced.

### CITATION LIST

### Non Patent Literature

NPL 1: Huawei, HiSilicon, “Analysis on control signaling enhancements”, R1-130892, Chicago, USA, Apr. 15-19, 2013.

### SUMMARY OF INVENTION

### Technical Problem

MSS makes it necessary to control a plurality of PUSCHs (or PDSCHs) using one PDCCH, and thus increases the number of bits of a control signal per occurrence of allocation, as compared with the related art. An increase in the number of bits of a control signal causes a data channel region to be pressed, thus undesirably causing a reduction in system throughput.

The present invention has been made in view of the problems described above, and it is an object of the present invention to suppress a reduction in system throughput by suppressing an increase in control information.

### Solution to Problem

In order to solve the aforementioned problems, a transmission device according to the present invention is configured as follows:

(1) In order to solve the problems described above, a transmission device according to an aspect of the present invention is a terminal device for transmitting or receiving a data signal in a plurality of transmittable consecutive subframes according to one piece of allocation information, the transmission device including a TBS determining section that determines the number of information bits to which encoding is applied across the plurality of subframes.

(2) Further, the transmission device according to the aspect of the present invention further includes a transport block generating section that encodes a series of information bits composed of the number of information bits determined by the TBS determining section and adds a CRC code.

(3) The TBS determining section of the transmission device according to the aspect of the present invention determines the number of information bits to which encoding is applied across the plurality of subframes by multiplying, by the number of the plurality of subframes, the number of information bits of the data signal in a case where the data signal is transmitted or received in one subframe.

(4) The TBS determining section of the transmission device according to the aspect of the present invention determines the number of information bits to which encoding is applied across the plurality of subframes by multiplying, by the number of the plurality of subframes, the number of information bits of the data signal in a case where the data signal is transmitted or received in one subframe.

(5) In order to solve the problems described above, a transmission device according to an aspect of the present invention is a terminal device for transmitting or receiving a data signal in one subframe or a plurality of transmittable consecutive subframes according to one piece of allocation information, the transmission device transmitting reference signals in the plurality of subframes according to the one piece of allocation information.

(6) Further, the transmission device according to the aspect of the present invention is configured such that the reference signals are transmitted in subframes whose number is the same as the number of the plurality of subframes.

(7) In order to solve the problems described above, a transmission device according to an aspect of the present invention is a terminal device for transmitting or receiving a data signal in one subframe or a plurality of transmittable consecutive subframes according to one piece of allocation information, the transmission device determining the number of the plurality of subframes according to retransmission-related information that is notified together with the allocation information.

(8) Further, the transmission device according to the aspect of the present invention is configured such that the retransmission-related information is information indicating a first transmission or a retransmission, and in a case where the information indicates a retransmission, the data signal is transmitted or received in one subframe.

### Advantageous Effects of Invention

According to an aspect of the present invention, a reduction in downlink data rate can be suppressed by suppressing an increase in control information.

### BRIEF DESCRIPTION OF DRAWINGS

FIG. 1 is a diagram showing a wireless frame configuration according to a related art.

FIG. 2 is a diagram showing a resource block according to the related art.

FIG. 3 is a diagram showing a data transmission subframe according to the related art.

FIG. 4 is a diagram showing a data transmission subframe in multi-subframe scheduling according to the related art.

FIG. 5 is a schematic block diagram showing a configuration of a wireless communications system according to a first embodiment of the present invention.

FIG. 6 is a schematic block diagram showing a configuration of a base station apparatus according to the present embodiment.

FIG. 7 is a flow chart for determining a transport block size according to the related art.

FIG. 8 is a table according to the related art for determining a transport block size from I_{TBS} and N_{PRB} when the number of layers is 1.

FIG. 9 is a flow chart for determining a transport block size according to the present embodiment.

FIG. 10 is a flow chart for determining a transport block size according to the present embodiment.

FIG. 11 shows a modification of the flow chart for determining a transport block size according to the present embodiment.

FIG. 12 is a diagram showing timings of transmission of A-SRSs according to the related art.

FIG. 13 is a diagram showing a timing of transmission of an A-SRS according to a second embodiment of the present invention.

FIG. 14 is a diagram showing timings of transmission of a plurality of A-SRSs.

FIG. 15 is a schematic block diagram showing a configuration of a base station apparatus according to a third embodiment of the present invention.

FIG. 16 is a flow chart of a method for determining control information that is notified in a DCI format according to the present embodiment.

FIG. 17 is a table of association between RV bits and the numbers of subframes of MSS according to the first embodiment of the present invention.

FIG. 18 is a table according to the third embodiment of the present invention that shows the numbers of subframes of MSS in a case where the base station apparatus notifies a terminal device of control information in a DCI format 0.

FIG. 19 is a table according to the present embodiment that shows the numbers of subframes of MSS in a case where the base station apparatus notifies a terminal device of control information in a DCI format 4.

FIG. 20 is a table of MCS indices to the numbers of subframes of MSS according to the present embodiment.

### DESCRIPTION OF EMBODIMENTS

Embodiments of the present invention are described below with reference to the drawings.

### First Embodiment

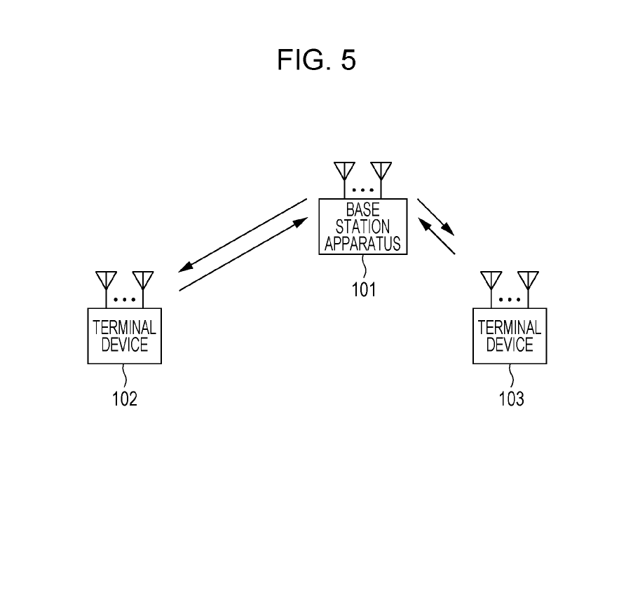

A first embodiment of the present invention is described below with reference to the drawings. FIG. 5 shows an example of a configuration of a wireless communications system according to the present embodiment. The system includes a base station apparatus 101, a terminal device 102, and a terminal device 103. It should be noted that the number of terminal devices is not limited to 2 and the number of antennas of each device may be 1. Further, although not illustrated in FIG. 5, a pico base station apparatus that performs transmissions with lower electric power than the base station apparatus may be provided in the system, and at least one of the terminal devices may perform communication with the pico base station.

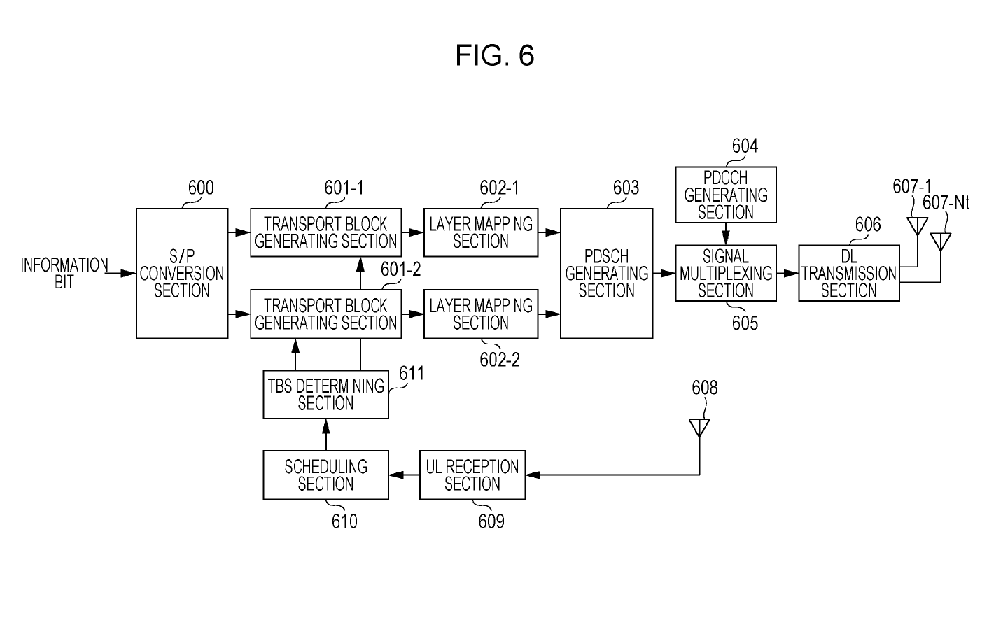

FIG. 6 shows an example of a configuration of the base station apparatus 101. It should be noted that FIG. 6 shows only blocks that are needed to describe the present invention. A signal transmitted by a terminal device is received by an UL reception section 609 via a receive antenna 608. It should be noted that reception quality may be improved by providing a plurality of the receive antennas 608 and applying existing technologies such as reception diversity and adaptive array antennas. The UL reception section 609 outputs, to a scheduling section 610, information that is needed for scheduling in the scheduling section 610. Examples of the information that is needed for scheduling include received SRSs (sounding reference signals), received SRs (scheduling requests), CSI (channel state information), and the like.

The scheduling section 610 outputs the number of RBs that are allocated to the terminal device (M), a transport block size (TBS) index (I_{TBS}), the number of layers (L), and, in a case of performing MSS, the number of multiple subframes (K) to a TBS determining section 611. It should be noted that I_{TBS} is a value that is calculated from an MCS (modulation and coding scheme). In a case where the number of code words is 2 at the time of MIMO transmission, a TBS index and the number of layers are received for each code word. It should be noted here that the number of layer does not refer to the number of streams of MIMO transmission, but indicates the number of layers multiplexed in each transport block. Therefore, the sum of the numbers of layers in each transport block is the number of streams of MIMO transmission. The TBS determining section 611 determines a TBS for each code word using the received information. As a method for determining a TBS, such a method as that described below is applied under the existing specifications (up to LTE Rel-11).

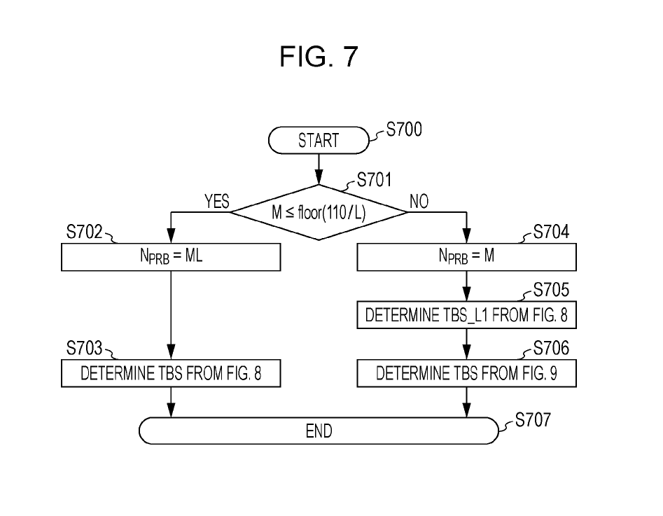

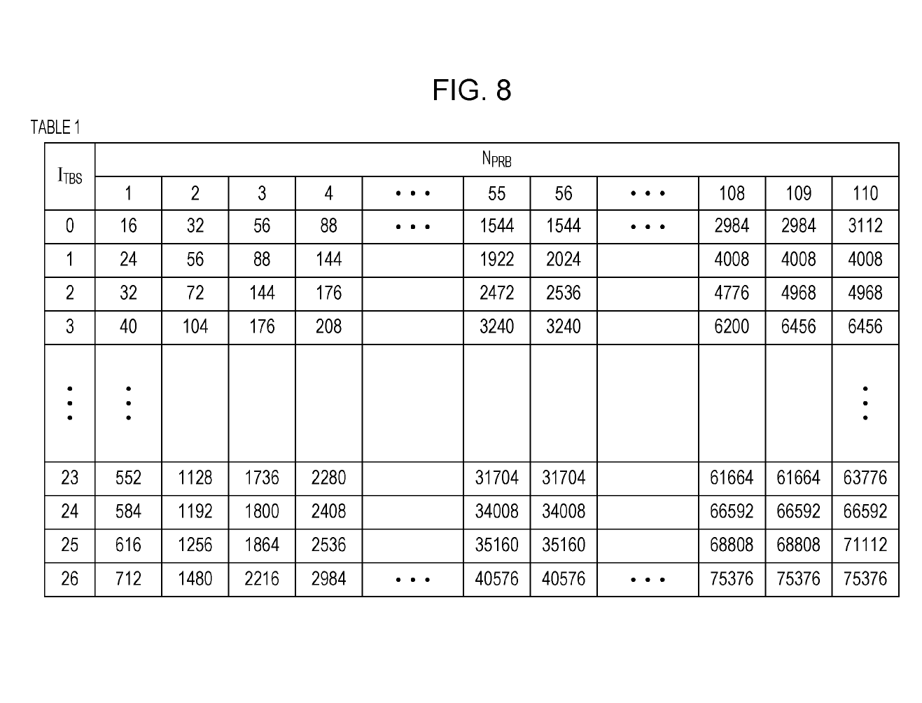

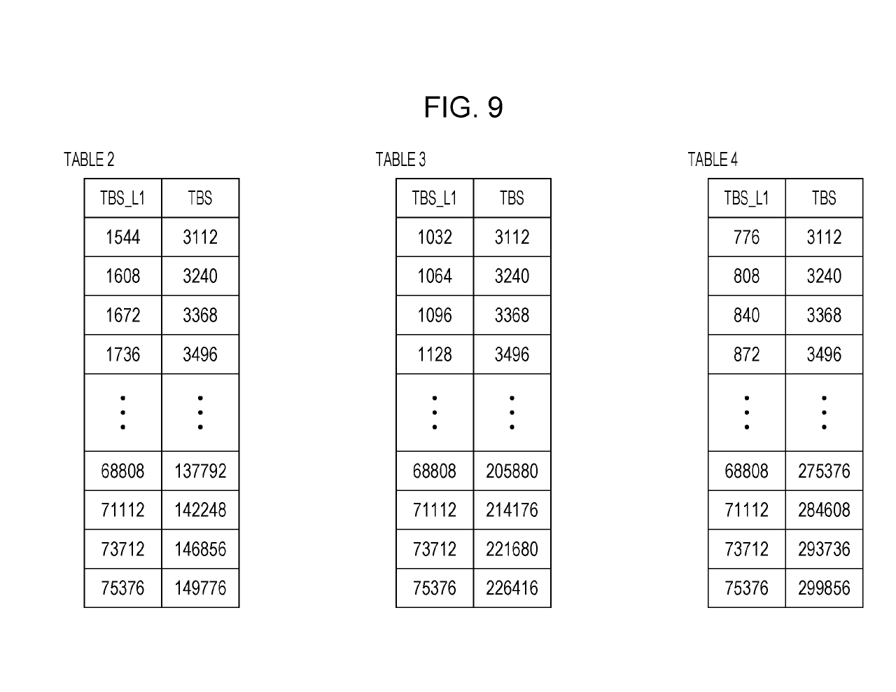

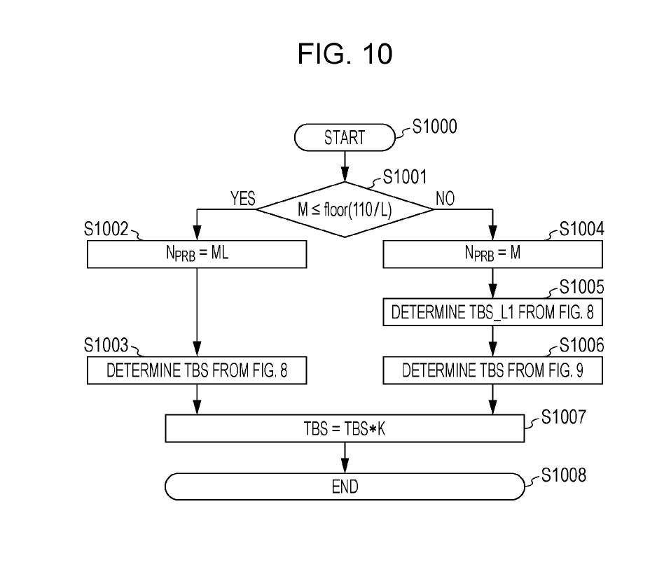

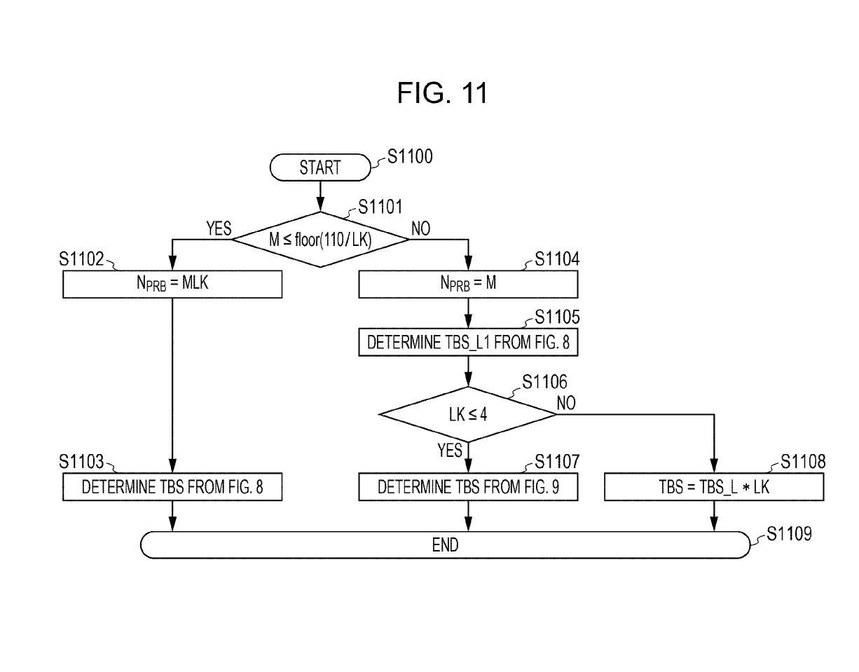

A process that the TBS determining section 611 performs on each code word using the method for determining a TBS under the existing specifications is described with reference to a flow chart shown in FIG. 7. First, a branch is performed according to a magnitude relationship between the number of allocated RBs M and floor(110/L) (S701). It should be noted that floor(X) is a function that outputs a maximum integer of not greater than X. In a case where M floor(110/L), N_{PRB} takes on a value ML (S702). Next, a value of TBS is obtained from (I_{TBS}, N_{PRB}) and a table (TABLE 1) shown in FIG. 8 (S703). Since the TBS has been calculated, the process ends (S707). It should be noted that the table shown in FIG. 8 is an excerpt from a table used in LTE, which is shown in Table 7.1.7.2.1-1 of 3GPP TS 36.213.

On the other hand, in a case where M>floor(110/L), N_{PRB} takes on a value M (S704). Next, a value of TBS_L1 is obtained from (I_{TBS}, N_{PRB}) and the table shown in FIG. 8 (S705). After that, a TBS is obtained from FIG. 9 and TBS_L1 (S706). At this time, Tables 2, 3, and 4 shown in FIG. 9 are used when L=2, 3, and 4, respectively. It should be noted that the tables shown in FIG. 9 are excerpts from tables used in LTE, which are shown in Table 7.1.7.2.2-1, Table 7.1.7.2.4-1, and Table 7.1.7.2.5-1 of 3GPP TS 36.213.

That is, in a case where the number of layers is 1, the table shown in FIG. 8, which is prepared for bandwidths up to 110 RBs, is used for the calculation of a TBS up to Rel-11. Further, the specifications are such that when the number of layers is other than 1, the table shown in FIG. 8 is used in a case where a value obtained by multiplying a bandwidth by the number of layers is not greater than 110 RBs, and that in a case where the value is greater than 110 RBs, a TBS is calculated from a value of TBS (TBS_L1) obtained from the table shown in FIG. 8 and the tables shown in FIG. 9, assuming that the number of layers is 1.

Note here that the introduction of MSS, which is under study in Rel-12, will enable the base station apparatus to notify the terminal device of allocation information on a plurality of subframes, thus making it possible to reduce control information related to the allocation information. However, for example in a DL data transmission, the terminal device receives a plurality of subframes and notifies the base station apparatus of an ACK/NACK of each frame via UL. That is, mere application of MSS cannot reduce the number of ACK/NACKs. Similarly, also in a case where MSS is applied to an UL data transmission, the number of ACK/NACKs of DL cannot be reduced. Therefore, the present embodiment defines a transport block that extends across a plurality of subframes. This makes it possible to reduce control information even when a transmission is performed using a plurality of subframes, as it is only necessary to notify the base station apparatus of one ACK/NACK.

Under the existing specifications, the maximum value of TBS is 299856 (e.g., when M=110 RBs, L=4, and I_{TBS}=26). However, the employment of MSS and the definition of a transport block that extends across a plurality of subframes will pose a risk of a transport block being generated by the number of bits that is greater than the maximum value. That is, under the existing specifications, a transport block that extends across a plurality of subframes cannot be achieved.

Now, an example of a method for, when K subframes are allocated by MSS, setting a transport block that extends across the K subframes is described with reference to a flow chart shown in FIG. 10. It should be noted that the following assumes that the same number of RBs are allocated in each subframe by MSS.

In FIG. 10, a TBS is found by the same method as that described with reference to the flow chart shown in FIG. 7. After that, in step S1007, a TBS calculated in step S1003 or step S1006 is multiplied by K and takes on the resulting value.

(Modification)

The use of the flow chart shown in FIG. 10 can define a transport block that extends across a plurality of subframes, without causing much of increase in circuit complexity. However, there is a high possibility that the desired quality is no longer satisfied or that the number of parity bits in encoding becomes redundant, because a TBS is calculated from FIG. 9 when (L, K)=(2, 1) and a TBS is calculated by doubling a TBS obtained from FIG. 8 when (L, K)=(1, 2), although the same TBS should be obtained both when (L, K)=(2, 1) and when (L, K)=(1, 2). Now, FIG. 11 shows a flow chart of a case where the tables shown in FIG. 9 is used as much as possible in defining a transport block that extends across a plurality of subframes. In FIG. 11, first, a branch is performed according to a magnitude relationship between the number of allocated RBs M and floor(110/LK) (S1101). In a case where M≦floor(110/LK), N_{PRB} takes on a value MLK (S1102). Next, in step S1103, a value of TBS is obtained from (I_{TBS}, N_{PRB}) and the table shown in FIG. 8, whereby the process ends (S1109).

On the other hand, in a case where M>floor(110/LK), N_{PRB} takes on a value M (S1104). Next, in step S1105, a value of TBS_L1 is obtained from (I_{TBS}, N_{PRB}) and the table shown in the drawing. Next, in a case where LK≦4, a TBS is obtained from the tables shown in FIG. 9 and the value of TBS_L1 in step S1107, whereby the process ends (S1109). On the other hand, in a case where LK>4, a TBS is obtained by multiplying the value of TBS_L1 by LK in step S1108, whereby the process ends (S1109). This is because Rel-11 has no corresponding table. It should be noted that in a case where the great common devisor G of KL is 2, 3, or 4 in step S1108, a TBS may be found by the tables shown in FIG. 9 and G, and a TBS may be calculated by multiplying the value by (LK/G).

That is, in the modification, when a TBS is equal to or smaller than a size shown in the Rel-11 specifications, the table shown in the specifications is used, and when a TBS takes on a value that is greater than a size shown in the Rel-11 specifications, a TBS is calculated by multiplying a TBS shown in the Rel-11 specifications by a predetermined value. This makes it possible to introduce a transport block that extends across a plurality of subframes by making the maximum use of the results of the previous studies in the 3GPP and, at the same time, using a simple calculation in a range on which no studies has been carried out.

Further, in a case where LK>5, a table corresponding to 5, 6, 7, 8, . . . in addition to 2 to 4 may be separately prepared and used instead of step S1108, although the foregoing has illustrated an example of multiplication by a predetermined multiple number because such a case is not defined in the Rel-11 specifications. Defining a new table in this way can lower the possibility that the desired quality is no longer satisfied or that the number of parity bits in encoding becomes redundant, as compared with a case where a TBS is obtained by multiplying TBS_L1 by a predetermined value.

By using any of these methods for determining a TBS, the TBS determining section 611 determines a TBS for each code word and outputs the TBS to a transport block generating section 601-1 and a transport block generating section 601-2. It should be noted that in a case where the number of code words is 1, the transport block generating section 601-2 is not used.

An information bit is subjected to S/P (serial-parallel) conversion by an S/P conversion section 600. An output from the S/P conversion section 600 is received by the transport block generating section 601-1 and the transport block generating section 601-2.

The transport block generating section 601-1 and the transport block generating section 601-2 form transport blocks according to the received information bits and the TBS received from the TBS determining section 611, and output the transport blocks thus formed to a layer mapping section 602-1 and a layer mapping section 602-2, respectively.

The layer mapping section 602-1 and the layer mapping section 602-2 allocate the received transport blocks to one or more layers. Outputs from the layer mapping section 602-1 and the layer mapping section 602-2 are received by a PDSCH generating section 603. The PDSCH generating section 603 generates a PDSCH on which the received transport blocks are arranged across a plurality of subframes. The PDSCH thus generated is received by a signal multiplexing section 605.

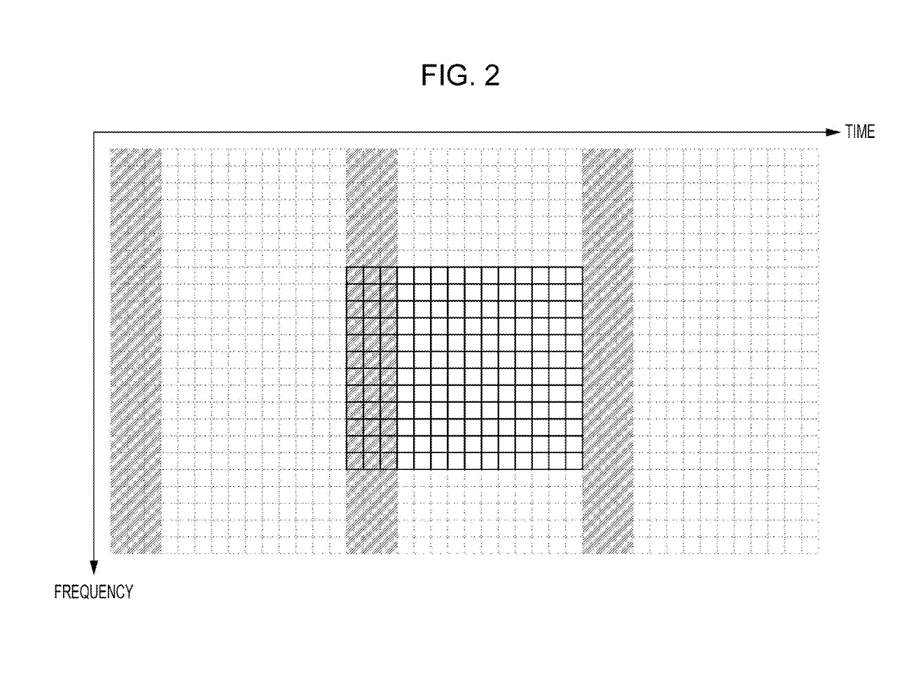

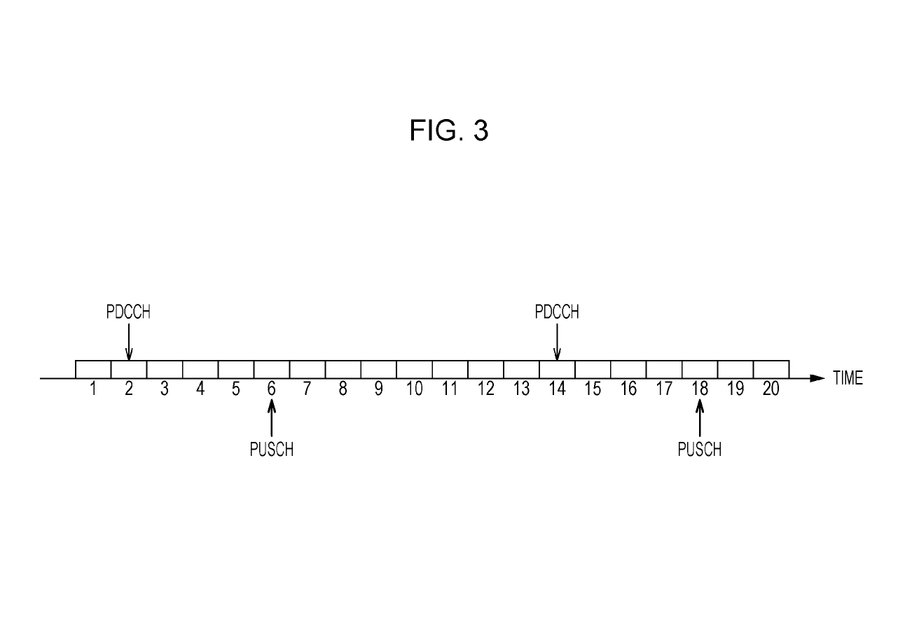

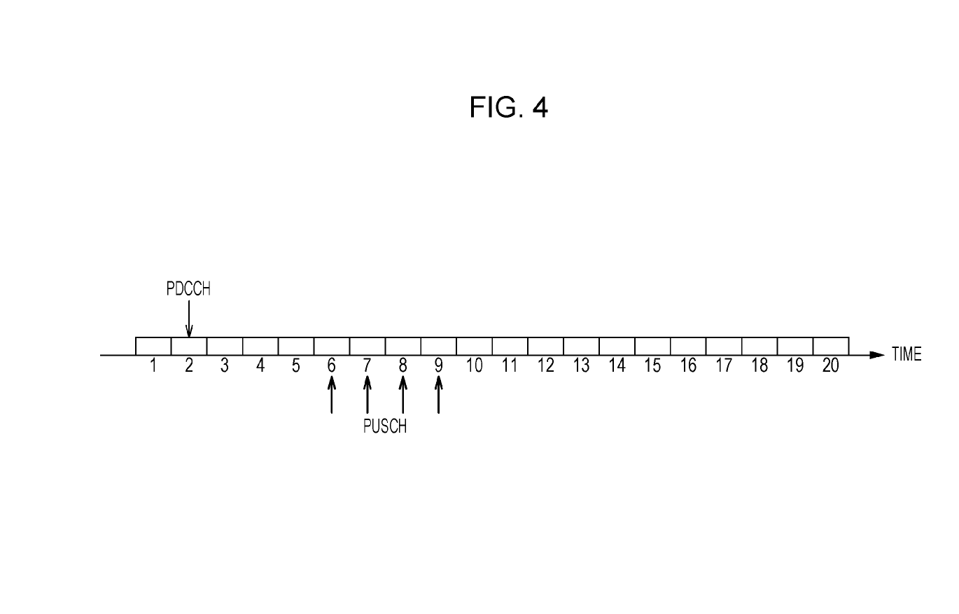

The signal multiplexing section 605 forms a frame configuration such as that shown in FIG. 2 by multiplexing the PDCCH received from the PDSCH generating section 603 and a PDCCH received from a PDCCH generating section 604. It should be noted that a PDCCH directed to a terminal device to which MSS is applied is disposed only in the first one of a plurality of subframes allocated. It should be noted that such subframe does not necessarily need to be the first subframe. Further, a PDCCH related to MSS is contained in any of the plurality of subframes, and control information not associated with MSS may be contained in the plurality of subframes. An example of the control information not associated with MSS is a TPC (transmit power control) commend, which is defined as a DCI format 3A in Rel-11 and transmitted on a PDCCH.

An output from the signal multiplexing section 605 is received by a DL transmission section 606, which generates transmission signals by IFFT (inverse fast Fourier transform), D/A (digital-to-analog) conversion, or up-conversion into carrier frequencies and transmits the transmission signals to the terminal device via transmit antennas 607-1 to 607-Nₜ. It should be noted that MSS is also applicable to UL, although the present embodiment has described MSS for DL. In that case, a terminal device is notified of allocation information from the base station apparatus, and MSS is applied in the same manner as in the case of DL on the basis of the allocation thus notified. This in turn makes it possible to reduce DL control information.

Thus, in a case where MSS is applied, a transport block that extends across a plurality of subframes is defined instead of a transport block being defined for each subframe as has conventionally been done. This eliminates the need to transmit as many ACK/NACK as subframes, thus enabling a reduction in control information.

### Second Embodiment

A second embodiment describes an example in which control signals that cause a terminal device to transmit SRSs (sounding reference signals) are reduced by MSS.

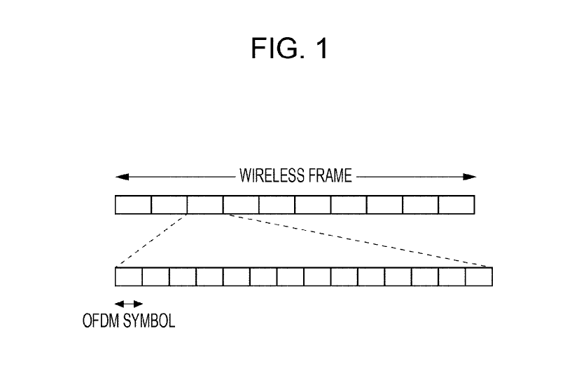

In LTE, a base station apparatus allocates, to each terminal device, a resource for performing an uplink transmission, and for appropriate allocation, it is necessary to grasp a channel between each terminal device and the base station apparatus. For this purpose, each terminal device is designed to periodically transmit reference signals called SRSs. An SRS is transmitted using the last symbol of one subframe (fourteen OFDM symbols) shown in FIG. 1. SRSs are not necessarily transmitted in all subframes, but are transmitted at intervals notified from the base station apparatus. The SRSs are called P-SRSs (periodic SRSs; trigger-type 0 SRSs), as they are periodically transmitted from the terminal device.

P-SRSs are not necessarily transmitted at timings when the base station needs them to be transmitted. Intervals between P-SRSs can be changed using RRCs. However, since intervals at which RRCs can be transmitted are long, P-SRSs are not necessarily transmitted at timings when they need to be transmitted.

Therefore, LTE Rel-10 introduces a mechanism in which SRSs, aside from P-SRSs, are transmitted at timings when the base station apparatus requests them to be transmitted. These non-periodic SRSs are called A-SRSs (aperiodic SRSs; trigger-type 1 SRSs).

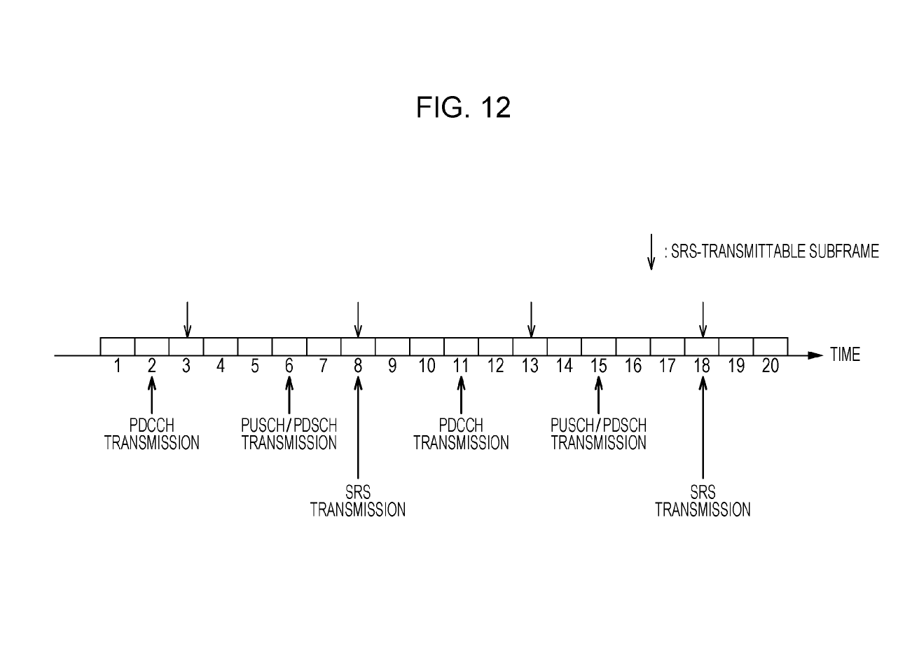

A bit for requesting an A-SRS is contained in downlink allocation notifying control information or uplink allocation notifying control information (PDCCH) of which the base station apparatus notifies the terminal device. In a case where the bit is 0, no A-SRS is transmitted. In a case where the bit is 1, an A-SRS is transmitted. However, A-SRS-transmittable subframes appear only at intervals. FIG. 12 shows an example of the case of FDD. In a case where a PDCCH is transmitted in the second subframe, a PUSCH or PDSCH transmission is performed in the sixth subframe, which is the fourth subframe after the second subframe. Note here that each downward arrow indicates a preset A-SRS-transmittable subframe, and that an A-SRS is transmitted in an A-SRS-transmittable subframe that comes for the first time after the (k+4)th subframe, where k is the subframe in which a PDCCH containing an A-SRS requesting bit was received. In the case shown in FIG. 12, an A-SRS is transmitted in the eighth subframe, since the eighth subframe is an A-SRS-transmittable subframe that comes for the first time. Similarly, in a case where a PDCCH is transmitted in the eleventh subframe, a PDSCH is transmitted in the fifteenth subframe and an A-SRS is transmitted in the eighteenth subframe. It should be noted that in the case of a PDCCH format 4, two bits are prepared in control information as bits for requesting an A-SRS. This enables the base station apparatus to designate any one of the following four patterns, that is, let no A-SRS be transmitted or let an A-SRS be transmitted on the basis of any one of the patterns of Configurations 1 to 3. These patterns differ from one another in bandwidths and intervals at which A-SRSs can be transmitted. The base station apparatus chooses one of these patterns in consideration of SRSs that other terminal devices transmit.

Under the specifications of LTE Rel-10, an A-SRS is transmitted in one subframe upon a request for an A-SRS. Meanwhile, the 3GPP also discussed multishot A-SRS, in which an A-SRS is transmitted across a plurality of subframes upon a request for an A-SRS. However, the adoption of the specifications was decided against, as notification of multishot A-SRS requires a vast amount of control information. The present embodiment describes a method for applying multishot A-SRS to MSS.

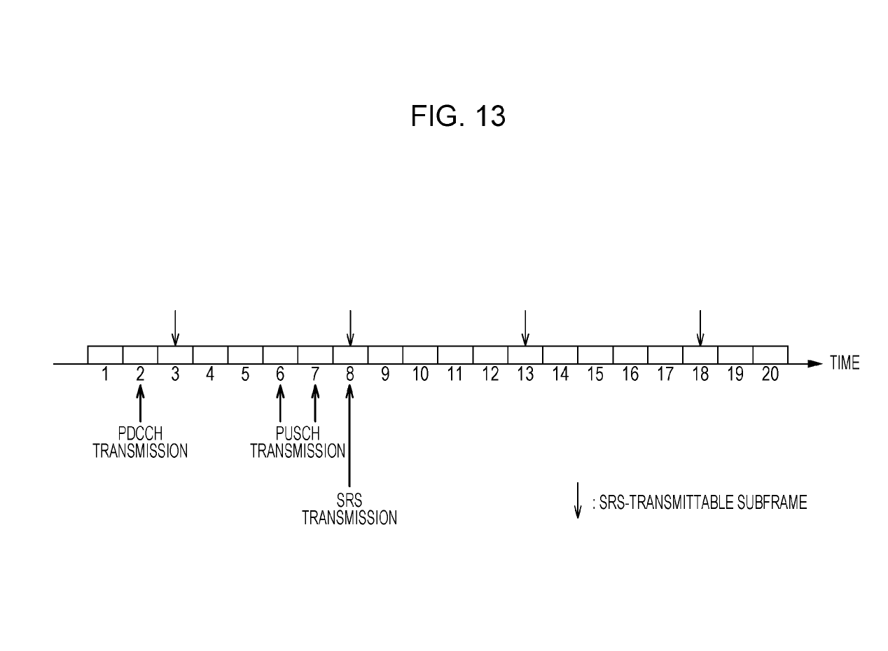

Suppose, for example, that transmissions such as those shown in FIG. 13 are performed. Unlike FIG. 12, FIG. 13 shows an example of a case of application of MSS in which two consecutive data transmissions are performed using a PDCCH in the second subframe. In LTE Rel-10, an A-SRS is transmitted only at a timing of A-SRS transmission that comes for the first time after the fourth subframe after the subframe in which the PDCCH was received. That is, in the case of this example, an A-SRS is transmitted only in the eighth subframe. Thus, in a case where MSS is not applied (FIG. 12), A-SRSs can be transmitted as many times as PUSCHs are transmitted; however, when MSS is applied, an A-SRS can be transmitted only once, although PUSCHs are transmitted in a plurality of subframes. This significantly reduces the chances of transmitting A-SRSs. This in turn disables the base station to grasp a channel of each terminal, makes appropriate scheduling impossible, and thus causes degradation in system throughput.

In applying MSS, the present embodiment gives thought to increasing the chances of transmitting A-SRSs. A terminal device moving at a high speed sharply fluctuates in channeling. Even when SRSs are transmitted, there are few advantages of transmitting SRSs, since channel states greatly vary according to timing of transmission of data. Meanwhile, to a terminal device to which MSS is applied, the same allocation can be applied across a plurality of subframes. That is, fluctuations in channeling are comparatively gentle; therefore, the effect of scheduling is remarkable, and the effect of transmitting SRSs is great.

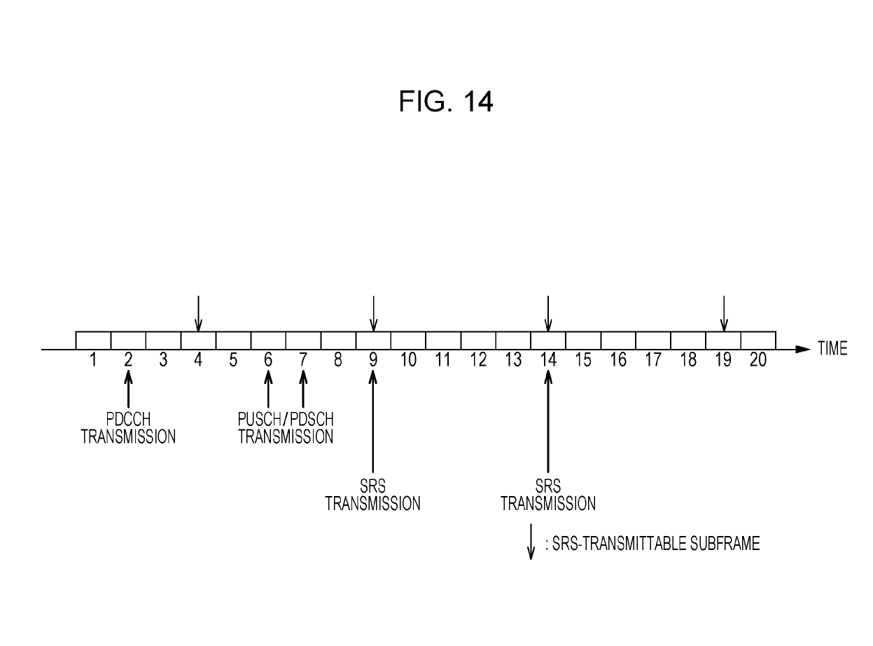

As such, a terminal device to which MSS is applied transmits a plurality of A-SRSs in response to reception of one PDCCH. For example, in a case where allocation across two subframes is applied as shown in FIG. 14, as has conventionally been done, an A-SRS is transmitted at a timing of A-SRS transmission that comes for the first time after the fourth subframe after the subframe in which the PDCCH was received. That is, in the case of this example, an A-SRS is transmitted in the ninth subframe. Furthermore, since two subframes are allocated by MSS, an A-SRS is also transmitted in the fourteenth subframe, which is the next timing of A-SRS transmission.

By thus performing multishot A-SRS in association with the application of MSS, multishot A-SRS can be applied without notification of control information as to whether multishot is applied. This control makes it possible to solve the problem of MSS reducing the chances of transmitting A-SRSs.

It should be noted that the number of subframes that are set by MSS and the number of A-SRSs that are transmitted do not need to be equal. For example, in a case where four subframes are set by MSS, the number of subframes divided by 2 may be the number of A-SRSs that are transmitted. Furthermore, in a case where the number of subframes divided by 2 is not a natural number, the number may be rounded up or rounded off. Moreover, the divisor is not limited to 2, but may take on any value. Furthermore, application of multiplication processing, square processing, or square-root processing instead of division is also encompassed in the present invention.

### Third Embodiment

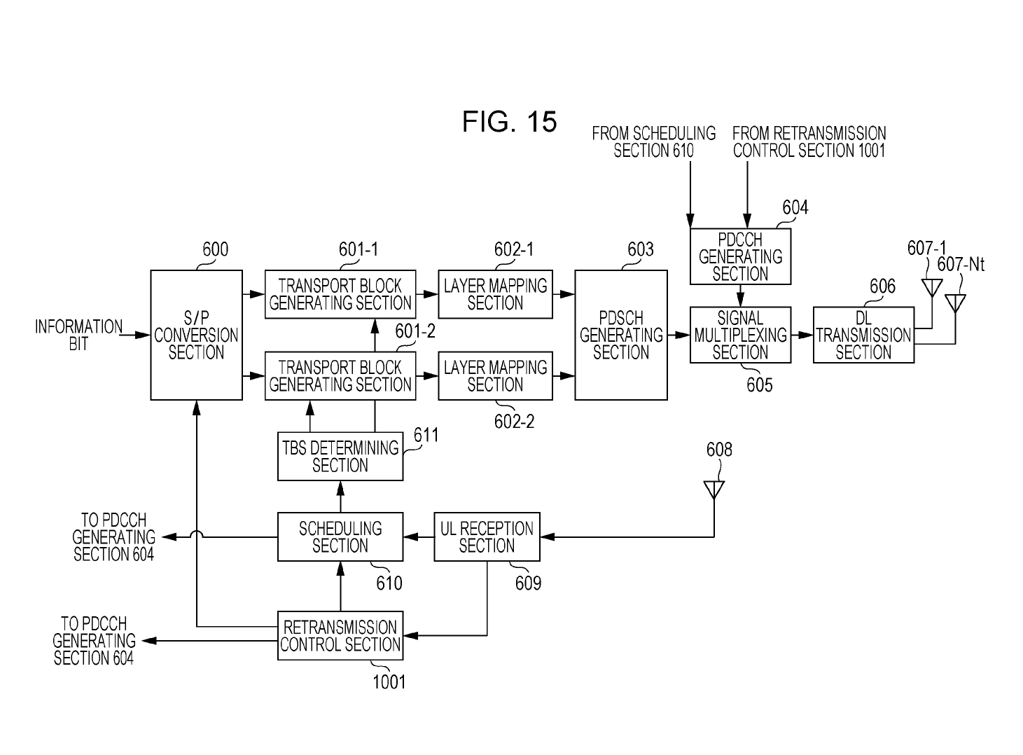

A third embodiment describes a method for notification of the number of subframes of MSS in a DL data transmission. FIG. 15 shows an example of a configuration of a base station apparatus that transmits data. The base station apparatus uses the scheduling section 610 to determine the allocation of frequency resources according to CSI received from one or more terminal devices. Assume here that scheduling includes cases of first transmission and retransmission in a mixed manner. Further, the scheduling section 610 also determines the number of subframes that are allocated by MSS, an MCS, the number of layers, and a TPC command for UL control information, as well as information on RBs that are allocated to each terminal device. According to the control information thus determined, the base station apparatus uses the TBS determining section 611 through the PDSCH generating section 603 to generate a data signal that is to be transmitted by DL. Further, the control information determined by the scheduling section 610 is outputted to the PDCCH generating section 604.

A retransmission control section 1001 receives from the UL reception section 609 an ACK/NACK with respect to DL data transmitted at an earlier timing. Upon receiving an NACK, the retransmission control section 1001 outputs to the scheduling section 610 an HARQ process number that is to be retransmitted for retransmission processing. The retransmission control section 1001 outputs to the S/P conversion section 600 the HARQ process number that is to be retransmitted, and causes the S/P conversion section 600 to output to the transport block generating sections 601 an information bit that is to be retransmitted. Furthermore, in addition to the HARQ process number, the retransmission control section 1001 outputs an RV (redundancy version) and an NDI (new data indicator) to the PDCCH generating section 604.

The PDCCH generating section 604 converts the received control information into a predetermined DCI (downlink control information) format, and outputs it to the signal multiplexing section 605. As the DCI format, a plurality of formats for use in DL are prepared, and the format that will be used is defined according to the transmission mode of DL. In LTE Rel-11, DCI formats 1, 1A, 1B, 1C, 2, 2A, 2B, 2C, and 2D are prepared as formats for use in DL. For example, the DCI format 1A, which is used for single antenna port transmission, contains information such as frequency resource allocation, an MCS, an HARQ process number, an NDI, an RV, a TPC command for UL control information, an SRS request, and an HARQ-ACK resource offset. These pieces of control information are determined by either the scheduling section 610 or the retransmission control section 1001, and are outputted to the PDCCH generating section 604.

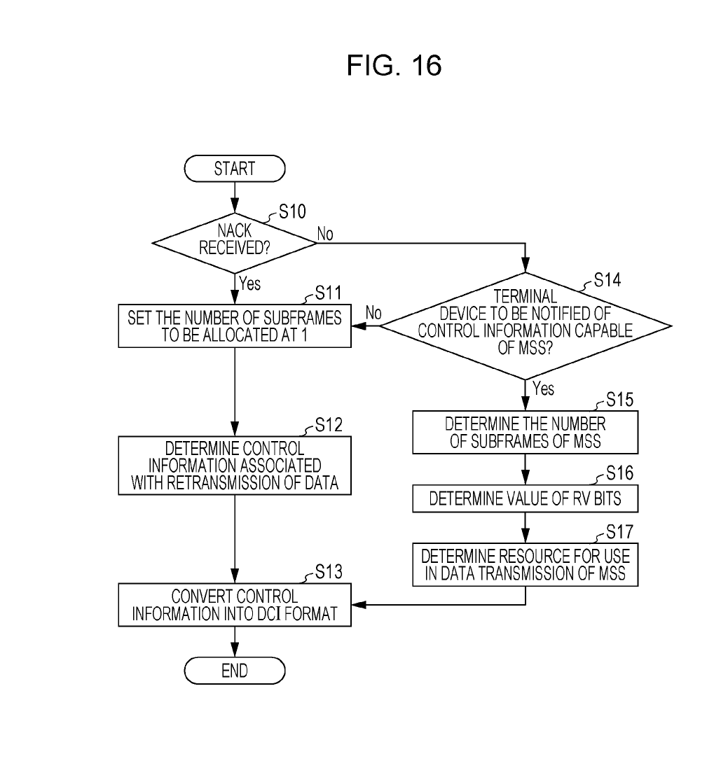

FIG. 16 shows an example of a flow chart of a method for determining control information that is notified in a DCI format according to the present embodiment. In step S10, the retransmission control section 1001 determines whether it has received an NACK. In a case where it has received an NACK, the process proceeds to step S11. In step 511, the scheduling section 610 sets the number of subframes to be allocated without application of MSS at 1. In step S12, the scheduling section 610 determines frequency resource allocation, an MCS, the number of layers, and a TPC command for UL control information, and outputs them to the PDCCH generating section 604. In step S12, the retransmission control section 1001 sets information for use in retransmission, such as an NDI, an RV, and an HARQ process number, and outputs the information to the PDCCH generating section 604. In step S13, the PDCCH generating section 604 converts the control thus determined into a DCI format.

On the other hand, in a case where the retransmission control section 1001 determines in step S10 that it has not received an NACK, the process proceeds to step S14. In step S14, the scheduling section 610 determines whether a terminal device to be notified of the control information is capable of data reception by MSS. Note here that examples of how to determine the capability of data reception by MSS include determination based on information of which the terminal device has notified the base station apparatus using an FGI (feature group indicator), determination based on notification of MSS-enabled settings to the terminal device by the base station apparatus by RRC (radio resource control) signaling, and the like. Without being limited to these examples, the capability of data reception by MSS may be determined according to whether the terminal device uses a C-RNTI (cell-radio network temporary identifier) or a temporary C-RNTI for detection of a PDCCH serving as control information. In a case where the scheduling section 610 determines in step S14 that the terminal device to be notified of the control information is not capable of data reception by MSS, the process proceeds to step S11. In a case where the scheduling section 610 determines in step S14 that the terminal device to be notified of the control information is capable of data reception by MSS, the process proceeds to step S15.

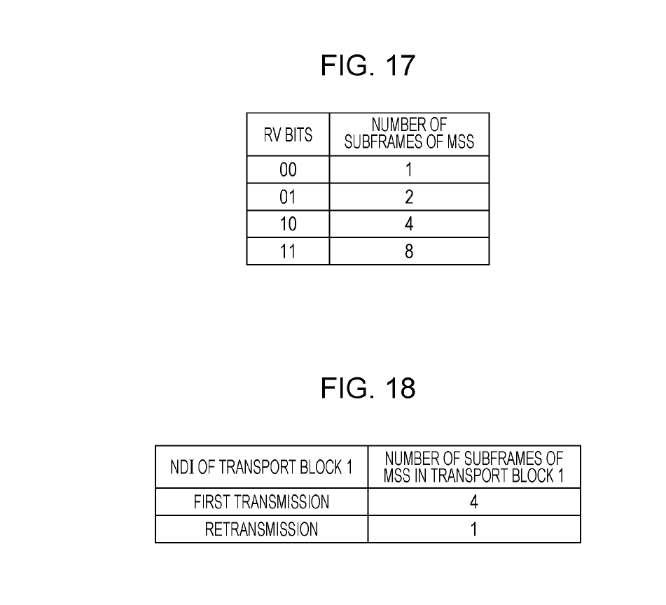

In step S15, the scheduling section 610 determines the number of subframes of MSS. The number of subframes of MSS is determined according to the amount of information that is transmitted by DL, whether MIMO transmission is applied, information on the MCS, and the like. In step S15, the scheduling section 610 converts information indicating the number of subframes of MSS thus determined into RV bits. FIG. 17 shows an example of notification of the number of subframes of MSS using RV bits. In DL, the number of RV bits is 2. Therefore, as shown in FIG. 17, the base station apparatus notifies the terminal device of a two-bit value and the number of MSS subframes in association with each other. Since FIG. 17 is merely an example, the RV bits and the numbers of subframes of MSS may be associated with each other in a different manner. In step S17, the scheduling section 610 determines another piece of control information that is notified in a DCI format. Then, the process proceeds to step S13.

This makes it possible, in the case of an NDI indicating a first transmission, to notify the number of subframes of MSS using RV bits, thus enabling notification of the number of subframes of MSS without increasing the amount of control information. This makes it possible to suppress an overhead increase in the amount of control information.

### Fourth Embodiment

A fourth embodiment describes a method for notification of the number of subframes of MSS in an UL data transmission. As in the third embodiment, FIG. 15 shows an example of a configuration of a base station apparatus that transmits control information. Control information for notification of a resource for use in an UL data transmission comes in either a DCI format 0 for use in single antenna port transmission or a DCI format 4 for use in multi-antenna port transmission. The DCI format 0, which is used for single antenna port transmission, contains information such as frequency resource allocation, an MCS, an NDI, an RV, a TPC command for UL data, an SRS request, and a demodulating reference signal cyclic shift index.

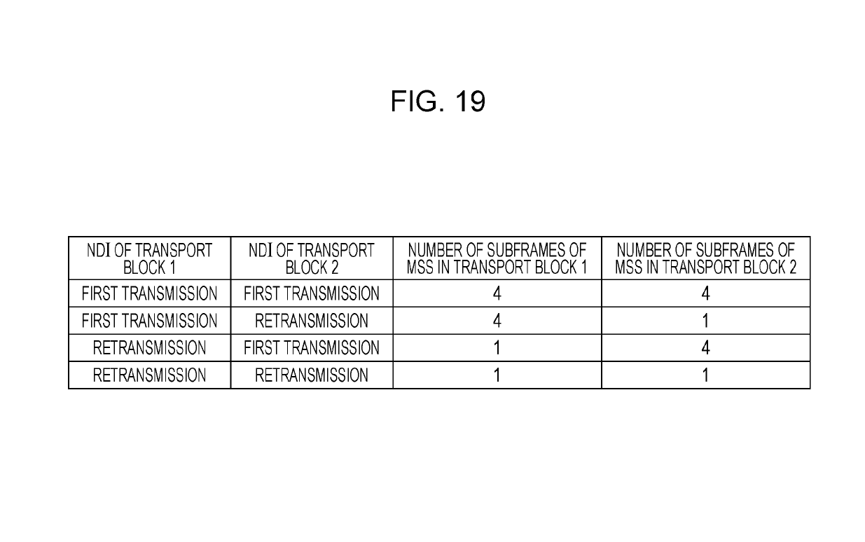

The retransmission control section 1001 receives from the UL reception section 609 an ACK/NACK serving as information indicating whether the UL reception section 609 successfully detected UL data. In a case where the UL data is an NACK, the retransmission control section 1001 outputs the information on the NACK to the scheduling section 610 in order to allocate a frequency resource for use in retransmission. Further, the retransmission control section 1001 generates an NDI bit(s), and outputs the NDI bit(s) to the PDCCH generating section 604. Note here that the number of NDI bits is 1 in the DCI format 0, and 2 in the DCI format 4. The present embodiment determines the number of subframes of MSS according to an NDI bit(s). FIGS. 18 and 19 show examples of notification of the numbers of subframes of MSS in the present embodiment. FIG. 18 shows a case where the base station apparatus notifies a terminal device of control information in the DCI format 0. In the case of an NDI indicating a first transmission, the number of subframes of MSS is 4, and in the case of an NDI indicating a retransmission, the number of subframes of MSS is 1. Next, FIG. 19 shows a case where the base station apparatus notifies a terminal device of control information in the DCI format 4. For each of two transport blocks, the number of subframes of MSS is switched between 4 and 1 for first transmissions and retransmissions. Although, in FIGS. 18 and 19, the number of subframes of MSS is 4 in the case of a first transmission, the number of subframes of MSS needs only be an integer of greater than 1.

The scheduling section 610 determines the allocation of frequency resources. Further, the scheduling section 610 also determines a CS, the number of layers, and a TPC command for UL data, as well as information on RBs that are allocated to each terminal device. The control information thus determined is outputted to the PDCCH generating section 604. The PDCCH generating section 604 generates control information in the DCI format 0 or 4 on the basis of the received control information, and outputs the control information to the signal multiplexing section 605.

This makes it possible to notify the number of subframes of MSS using an NDI, thus enabling notification of the number of subframes of MSS without increasing the amount of control information. This makes it possible to suppress an overhead increase in the amount of control information.

### Modification of the Fourth Embodiment

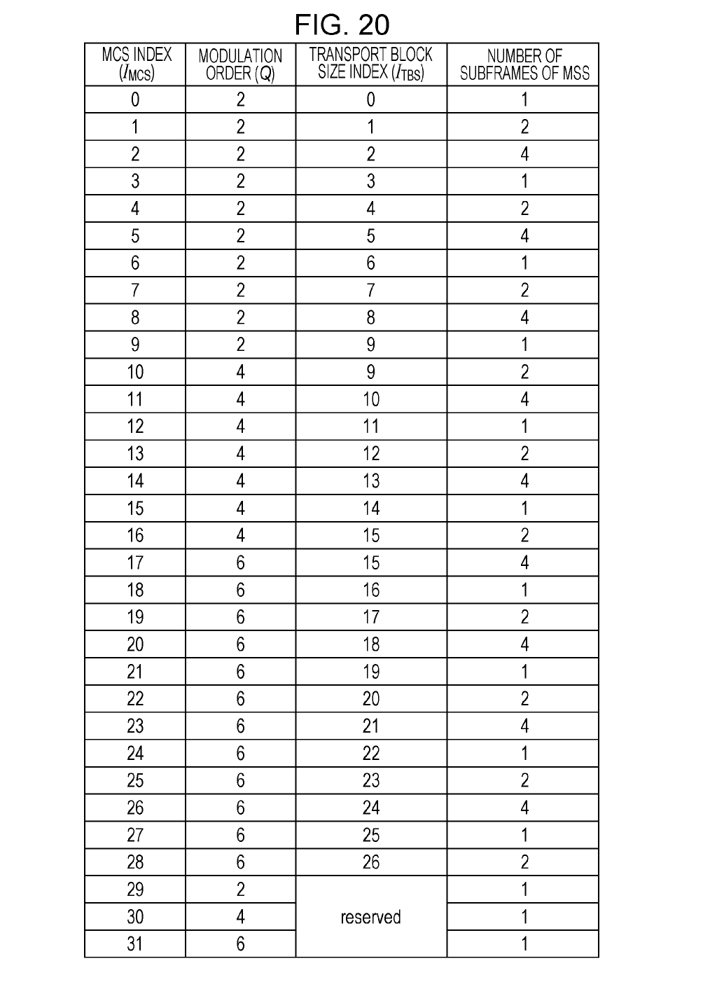

A modification of the fourth embodiment describes a method for notification of the number of subframes of MSS in an UL data transmission using an MCS index. As in the third embodiment, FIG. 15 shows an example of a configuration of a base station apparatus that transmits control information. In the present modification, the scheduling section 610 determines the number of subframes of MSS. The scheduling section 610 determines the number of subframes of MSS according to a buffer status report and information indicating whether UL MIMO transmission is applied. The buffer status report and the information are notified from a terminal device. After having determined the number of subframes of MSS, the scheduling section 610 determines an MCS. First, the scheduling section 610 measures reception quality estimated by SRSs and the like, and determines the MCS. Next, according to the MCS and the number of subframes of MSS thus determined, the scheduling section 610 determine, with reference to FIG. 20, an MCS index that is notified to the terminal device. An example of a method for determining an MCS index is to choose an MCS index being smaller than M_{ID} and located in a row where N_{sub} matches a table shown in FIG. 20. Note here that M_{ID} is the MCS index determined by the reception quality and N_{sub} is the number of subframes of MSS. However, the table shown in FIG. 20 is merely an example, and this example of the present embodiment does not imply any limitation. For example, in the case of a small MCS index, the number of subframes of MSS may be increased, as the number of information bits that can be transmitted is small. In the case of a large MCS index, the number of subframes of MSS may be decreased.

This makes it possible to notify the number of subframes of MSS in association with an MCS index, thus enabling notification of the number of subframes of MSS without increasing the amount of control information. This makes it possible to suppress an overhead increase in the amount of control information.

A program that runs on a base station and a terminal according to the present invention is a program that controls a CPU or the like (i.e., a program that causes a computer to function) so that the functions of the above-described embodiments of the present invention are achieved. Moreover, information that is used in these devices is temporarily accumulated in RAM during processing thereof, stored in various types of ROM or HDD after that, and read out by the CPU as needed for modification or writing. The program may be stored in any of the following storage media: semiconductor media (such as ROM and nonvolatile memory cards), optical storage media (such as DVDs, MOs, MDs, CDs, and BDs), and magnetic storage media (such as magnetic tapes and flexible disks). Further, not only are the functions of the embodiments described above achieved by executing the program loaded, but also the functions of the present invention may be achieved by executing processing in cooperation with an operating system or another application program on the basis of instructions from the program loaded.

Further, for market circulation, the program may be stored in a transportable storage medium for circulation, or may be transferred to a server computer connected via a network such as the Internet. In this case, a storage device of the server computer is also encompassed in the present invention. Further, some or all of the base stations and the terminals according to the embodiments described above may be achieved as an LSI, which is typically an integrated circuit. The functional blocks of the base stations and the terminals may be individually constructed in chip form, or all or some thereof may be integrated into chip form. Further, a technique of integrated circuit construction may be achieved by a dedicated circuit or a general-purpose processor as well as by LSI. In a case where the functional blocks are constructed in integrated circuit form, an integrated circuit control section that controls such integrated circuits is added.

Further, the technique of integrated circuit construction may be achieved by a dedicated circuit or a general-purpose processor as well as by LSI. Further, in a case where a technology of integrated circuit construction alternative to LSI comes out due to the advancement of technology, it is possible to use integrated circuits based on such a technology.

Further, the invention as set forth in the present application is not limited to the embodiments described above. A terminal of the invention as set forth in the present application is not limited to application to a mobile station apparatus, and can of course be applied to stationary or immovable electronic devices that are installed indoors or outdoors, such as audiovisual equipment, kitchen appliances, cleaning and washing machines, air-conditioning equipment, office devices, vending machines, and other domestic appliances.

In the foregoing, embodiments of the present invention have been described in detail with reference to the drawings. However, a specific configuration is not limited to these embodiments, and design variations and the like are also encompassed, provided such variations do not depart from the scope of the invention. Further, the present invention may be altered in various ways within the scope of the claims, and an embodiment based on a proper combination of technical means disclosed in different embodiments is encompassed in the technical scope of the present invention. Further, a configuration in which elements described in the embodiments above and having the same effect are replaced with each other is also encompassed.

### INDUSTRIAL APPLICABILITY

The present invention is suitably applicable to wireless base stations, wireless terminals, wireless communications systems, and wireless communications methods.

### REFERENCE SIGNS LIST

101 Base station apparatus

102 Terminal device

103 Terminal device

301 Transmission signal selecting section

600 S/P conversion section

601 Transport block generating section

602 Layer mapping section

603 PDSCH generating section

604 PDSCH generating section

605 Signal multiplexing section

606 DL transmission section

607 Transmit antenna

608 Receive antenna

609 UL reception section

610 Scheduling section

611 TBS determining section

1001 Retransmission control section

1. A terminal device for transmitting or receiving a data signal in a plurality of transmittable consecutive subframes according to one piece of allocation information,
the transmission device comprising a TBS determining section that determines the number of information bits to which encoding is applied across the plurality of subframes.

2. The transmission device according to claim 1, further comprising a transport block generating section that encodes a series of information bits composed of the number of information bits determined by the TBS determining section and adds a CRC code.

3. The transmission device according to claim 1, wherein the TBS determining section determines the number of information bits to which encoding is applied across the plurality of subframes by multiplying, by the number of the plurality of subframes, the number of information bits of the data signal in a case where the data signal is transmitted or received in one subframe.

4. The transmission device according to claim 1, wherein the TBS determining section determines the number of information bits to which encoding is applied across the plurality of subframes by multiplying, by the number of the plurality of subframes, the number of information bits of the data signal in a case where the data signal is transmitted or received in one subframe.

5. A terminal device for transmitting or receiving a data signal in one subframe or a plurality of transmittable consecutive subframes according to one piece of allocation information,
the transmission device transmitting reference signals in the plurality of subframes according to the one piece of allocation information.

6. The transmission device according to claim 5, wherein the reference signals are transmitted in subframes whose number is the same as the number of the plurality of subframes.

7. A terminal device for transmitting or receiving a data signal in one subframe or a plurality of transmittable consecutive subframes according to one piece of allocation information,
the transmission device determining the number of the plurality of subframes according to retransmission-related information that is notified together with the allocation information.

8. The transmission device according to claim 7, wherein the retransmission-related information is information indicating a first transmission or a retransmission, and in a case where the information indicates a retransmission, the data signal is transmitted or received in one subframe.
